(19) United States
(12) Patent Application Publication
(10) Pub. No.: US 2015/0103146 A1
(43) Pub. Date: Apr. 16, 2015

(54) CONVERSION OF AT LEAST ONE NON-STEREO CAMERA INTO A STEREO CAMERA

(71) Applicant: QUALCOMM Incorporated, San Diego, CA (US)

(72) Inventors: Gregory Gordon Rose, San Diego, CA (US); Franklin Peter Antonio, Del Mar, CA (US); Chong Uk Lee, Cupertino, CA (US)

(73) Assignee: QUALCOMM Incorporated, San Diego, CA (US)

(21) Appl. No.: 14/055,157

(22) Filed: Oct. 16, 2013

(51) Int. Cl. H04N 13/02

(52) U.S. Cl. CPC H04N 13/0239
USPC 348/47

(57) ABSTRACT

Methods, apparatuses, and devices are described for converting non-stereo cameras into a stereo camera. At least one optical element may be used to temporarily change an effective position and an effective orientation of a first non-stereo camera. The changed effective position may be displaced from an effective position of a second non-stereo camera by a predetermined distance, and the changed effective orientation may provide the first non-stereo camera with a field of view that overlaps a field of view of the second non-stereo camera. The at least one optical element may be used to capture a first image with the first non-stereo camera. A second image may be captured with the second non-stereo camera. The second image may have a frame of reference displaced from a frame of reference of the first image by the predetermined distance.

### BACKGROUND

The following relates generally to stereo cameras, and more specifically to a conversion of at least one non-stereo camera into a stereo camera.

Non-stereo cameras capture a single image at a time from a single perspective. Currently, when a non-stereo camera is used to capture stereo photographs, a user may capture a first image of a scene from a first perspective, and then move the camera to a second location to capture another image of the scene from another perspective. The distance the camera is moved, however, is not known by the stereo image processing software of the mobile device that houses the camera. As a result, there is no absolute scale factor available to the stereo image processing software, and it may be difficult to determine the scale of a reconstructed scene. A current solution to the absence of an absolute scale factor includes attempting to recognize a common object in the images of the scene, which common object has a known size (e.g., a DVD cover, a credit card, a power socket, etc.). A scale factor may then be calculated based on the known size of the object. Another current solution to the absence of an absolute scale factor includes using an accelerometer as an inertial navigation system to estimate the displacement between captured images of the same scene. These current solutions, however, do not provide an absolute scale factor for use in reconstructing a scene.

### SUMMARY

The described features generally relate to one or more improved methods, apparatuses, and/or devices for converting non-stereo cameras into a stereo camera. The methods, apparatus, and/or devices utilize at least one optical element to temporarily change an effective position and an effective orientation of a first non-stereo camera. The at least one optical element displaces the effective position of the first non-stereo camera from an effective position of a second non-stereo camera by a predetermined distance, while the effective orientation of the first non-stereo camera causes the field of view of the first non-stereo camera to overlap the field of view of the second non-stereo camera.

In a first set of illustrative embodiments, a method for converting non-stereo cameras into a stereo camera is described. In one configuration, at least one optical element may be used to temporarily change an effective position and an effective orientation of a first non-stereo camera. The changed effective position may be displaced from an effective position of a second non-stereo camera by a predetermined distance, and the changed effective orientation may provide the first non-stereo camera with a field of view that overlaps a field of view of the second non-stereo camera. The at least one optical element may be used to capture a first image with the first non-stereo camera. A second image may be captured with the second non-stereo camera. The second image may have a frame of reference displaced from a frame of reference of the first image by the predetermined distance.

In certain examples, the at least one optical element may temporarily fix a displacement between the effective position of the first non-stereo camera and an effective position of the second non-stereo camera by the predetermined distance.

In certain examples, the at least one optical element may include a mirror that reflects the first image toward the first non-stereo camera.

In certain examples, the at least one optical element may include a lens that focuses the first image at the first non-stereo camera.

In certain examples, the at least one optical element may include a light pipe that propagates the first image toward the first non-stereo camera.

In certain examples, the at least one optical element may be attached to a mobile device containing the first non-stereo camera and the second non-stereo camera.

In certain examples, the at least one optical element may be snapped to a mobile device containing the first non-stereo camera and the second non-stereo camera.

In certain examples, the first non-stereo camera may include a front facing camera of a mobile device and the second non-stereo camera may include a rear facing camera of the mobile device.

In certain examples, the first image and the second image may be captured simultaneously.

In certain examples, a button may be pressed to initiate capture of both the first image and the second image. In such examples, pressing the button may cause a mobile device to calculate a size of at least one common object in the first image and the second image based at least in part on the predetermined distance between the frame of reference of the first image and the frame of reference of the second image. Pressing the button may also cause the mobile device to perform a mathematical reconstruction of a scene based at least in part on the calculated size of the at least one common object in the first image and the second image.

In certain examples, the at least one optical element may be used to temporarily split the field of view of the first non-stereo camera into first and second overlapping fields of view.

In certain examples, the at least one optical element may be used to temporarily split the field of view of the second non-stereo camera into first and second overlapping fields of view.

In a second set of illustrative embodiments, an apparatus for converting non-stereo cameras into a stereo camera is described. In one configuration, the apparatus may include a means for capturing a first image, a means for capturing a second image, and an optical means for temporarily changing an effective position and an effective orientation of the means for capturing the first image while capturing the first image. The second image may have a frame of reference displaced from a frame of reference of the first image by a predetermined distance. The changed effective position of the means for capturing the first image may be displaced from an effective position of the means for capturing the second image by the predetermined distance, and the changed effective orientation may provide the means for capturing the first image with a field of view that overlaps a field of view of the means for capturing the second image.

In certain examples, the apparatus may include means for implementing one or more aspects described above with respect to the method of the first set of illustrative embodiments.

In a third set of illustrative embodiments, another apparatus for converting non-stereo cameras into a stereo camera is described. In one configuration, the apparatus may include a first non-stereo camera to capture a first image, a second non-stereo camera to capture a second image, and at least one optical element for temporarily changing an effective position and an effective orientation of the first non-stereo camera during capture of the first image. The second image may have a frame of reference displaced from a frame of reference of the first image by a predetermined distance. The changed effective position of the first non-stereo camera may be displaced from an effective position of the second non-stereo camera by the predetermined distance, and the changed effective orientation may provide the first non-stereo camera with a field of view that overlaps a field of view of the second non-stereo camera.

In certain examples, the instructions may be further executable by the processor to implement one or more aspects described above with respect to the method of the first set of illustrative embodiments.

In a fourth set of illustrative embodiments, a device for converting non-stereo cameras into a stereo camera is described. In one configuration, the device may include at least one optical element for temporarily changing an effective position and an effective orientation of a first non-stereo camera during capture of a first image, and at least one attachment member configured to attach the at least one optical element to a mobile device containing the first non-stereo camera and the second non-stereo camera. The changed effective position may be displaced from an effective position of a second non-stereo camera by a predetermined distance, and the changed effective orientation may provide the first non-stereo camera with a field of view that overlaps a field of view of the second non-stereo camera.

In certain examples, the at least one attachment member may include at least one biased member configured to snap the at least one optical element to a mobile device containing the first non-stereo camera and the second non-stereo camera.

In certain examples, the first non-stereo camera may include a front facing camera of a mobile device, and the second non-stereo camera may include a rear facing camera of the mobile device.

In certain examples, the at least one optical element may include a mirror that reflects the first image toward the first non-stereo camera.

In certain examples, the at least one optical element may include a lens that focuses the first image at the first non-stereo camera.

In certain examples, the at least one optical element may include a light pipe that propagates the first image toward the first non-stereo camera.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example of a wireless communications system;

FIG. 2 is a block diagram of an example of a mobile device having a non-stereo camera module and a stereo camera module according to various embodiments;

FIG. 3 is a block diagram of an example of a mobile device having first and second non-stereo cameras and a stereo camera module according to various embodiments;

FIG. 4 is a block diagram of an example of a mobile device having a non-stereo camera and a stereo camera module according to various embodiments;

FIG. 5 is a block diagram of an example of a mobile device having a stereo camera module with a remote processing manager according to various embodiments;

FIG. 6 is a block diagram of an example of a mobile device according to various embodiments;

FIGS. 7A and 7B show respective front and rear views of a mobile device having a front facing camera and a rear facing camera;

FIG. 8A shows a side view of a mobile device to which at least one optical element is attached;

FIG. 8B shows a bottom view of a mobile device to which at least one optical element is attached;

FIG. 9 shows another side view of a mobile device to which at least one optical element is attached;

FIG. 10 is a flowchart of a method for converting non-stereo cameras into a stereo camera;

FIG. 11 is a flowchart of another method for converting non-stereo cameras into a stereo camera; and

FIG. 12 is a flowchart of a method for converting a non-stereo camera into a stereo camera.

### DETAILED DESCRIPTION

The conversion of one or more non-stereo cameras into a stereo camera is described. As previously discussed, a non-stereo camera may be used to capture stereo photographs by capturing a first image of a scene from a first perspective, and then moving the non-stereo camera to a second location to capture another image of the scene from another perspective. However, the distance the camera is moved is not known by the stereo image processing software of the mobile device that houses the camera. As a result, there is no absolute scale factor available to the stereo image processing software.

Currently available smart phones typically have two cameras—a front facing camera and a rear facing camera. Because the cameras are oriented in opposite directions, they are non-stereo cameras. However, if an optical device could change the effective position and effective orientation of one of the cameras, the front and rear facing non-stereo cameras could be provided with overlapping fields of view such that the non-stereo cameras could be converted into a stereo camera. If the optical device was detachable from the smart phone, the optical device could be attached to temporarily change the effective position and effective orientation of one of the cameras, and then detached when the user did not want to use a stereo camera. The optical elements described herein may also be attached to a device with a single non-stereo camera in order to convert this single non-stereo camera into a stereo camera.

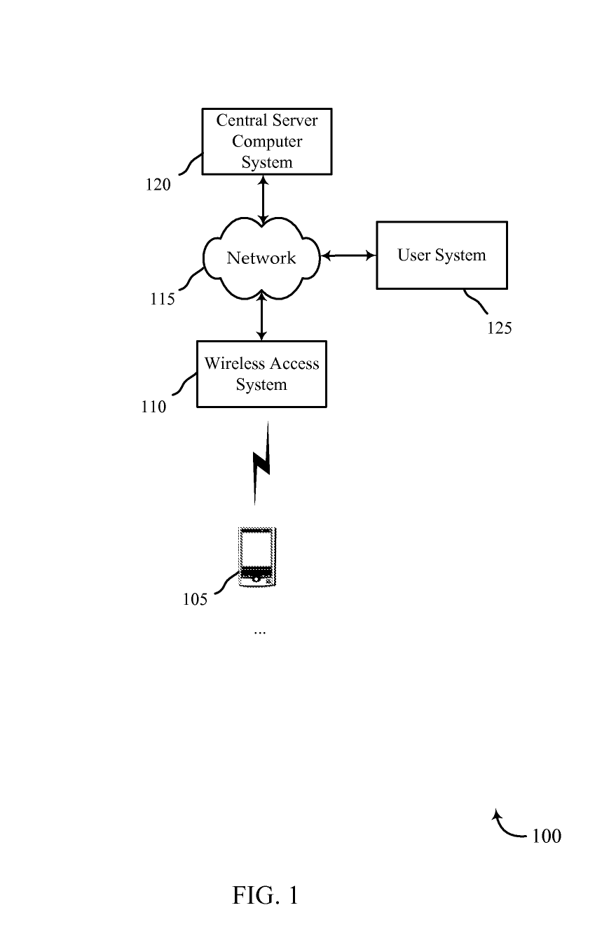

Referring first to FIG. 1, a block diagram illustrates an example of a wireless communications system 100 that includes at least one mobile device 105. The mobile device 105 may be any one of a number of types of devices, such as a cellular telephone, a smart phone, a laptop computer, a personal digital assistant (PDA), a camera, a gaming device, an e-reader, a tablet computer, a portable digital music player, or another mobile device that communicates voice and/or data, or any combination of the foregoing. In some embodiments, the mobile device 105 may also or alternately communicate via a wired communications system. In some embodiments, the mobile device 105 may be a camera or other mobile device having no ability to connect to a communications system.

The mobile device 105 may in some cases connect to a network 115 of the wireless communications system 100 via a wireless access system 110. The wireless access system 110 and network 115 may be capable of transmitting data using any of a number of different wireless protocols. Such wireless access systems and wireless networks are well known and need not be described in further detail here. In some cases, the network 115 may be or include the Internet. In other cases, the network 115 may be or include a cellular network. The wireless access system 110 may include a number of access points, each of which may provide communication coverage for a respective coverage area. In some embodiments, an access point may take the form of a base station, a base transceiver station, a radio base station, a radio transceiver, a basic service set (BSS), an extended service set (ESS), a NodeB, an evolved NodeB (eNB), a Home NodeB, a Home eNodeB, a wireless local area network (WLAN) access point, or some other form of access point.

The wireless communications system 100 may include a central server computer system 120 which may, for example, be made up one or more server computers, personal computers, workstations, web servers, or other suitable computing devices, and the individual computing device(s) for a given server may be local or remote from each other. In various embodiments, the central server computer system 120 may receive images and image processing requests from the mobile device 105. For example, the central server computer system 120 may reconstruct images the images it receives from the mobile device 105 into three-dimensional images.

A wireless communications system 100 may also include a user system 125 which may, for example, be a personal computer or console to which the mobile device 105 may connect. In various embodiments, the user system 125 may receive images and image processing requests from the mobile device 105. For example, the user system 125 may reconstruct images the images it receives from the mobile device 105 into three-dimensional images.

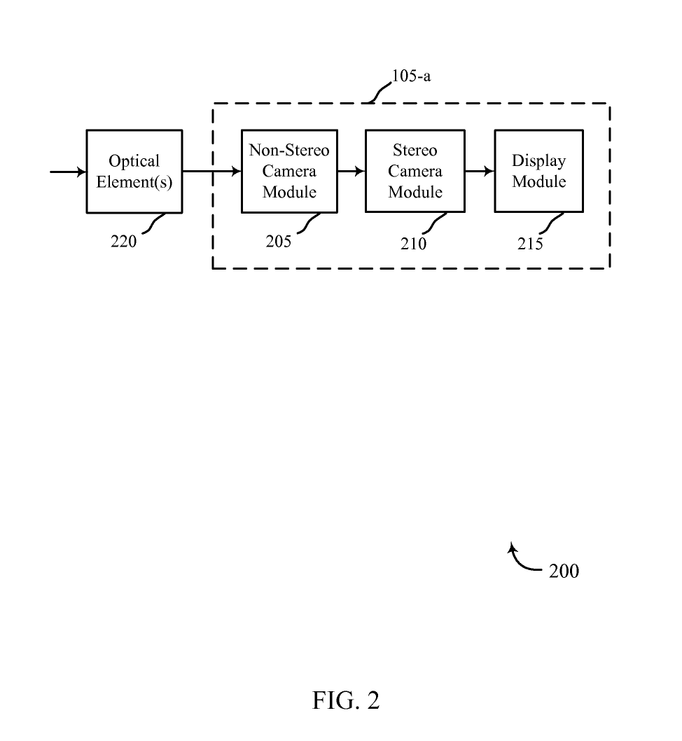

Referring now to FIG. 2, a block diagram 200 illustrates an apparatus including a mobile device 105-a and at least one optical element 220 for converting at least one non-stereo camera of the device 105-a into a stereo camera, in accordance with various embodiments. The mobile device 105-a may be an example of one or more aspects of the mobile device 105 described with reference to FIG. 1. The mobile device 105-a may include a non-stereo camera module 205, a stereo camera module 210, and/or a display module 215. Each of these components may be in communication with each other.

The components of the mobile device 105-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The non-stereo camera module 205 may include one or more non-stereo cameras. Each non-stereo camera may incorporate a complimentary metal-oxide semiconductor (CMOS) sensor or a sensor of another technology by which an image may be captured for display and/or digital processing.

The at least one optical element 220 may reflect, focus, propagate, and/or redirect an image toward, or towards, at least one non-stereo camera of the non-stereo camera module 205. For example, in an embodiment in which the non-stereo camera module 205 includes a first non-stereo camera to capture a first image and a second non-stereo camera to capture a second image, the at least one optical element 220 may temporarily change an effective position and an effective orientation of the first non-stereo camera during capture of the first image. The changed effective position may be displaced from an effective position of the second non-stereo camera by a predetermined distance, and the changed effective orientation may provide the first non-stereo camera with a field of view that overlaps a field of view of the second non-stereo camera. In some embodiments, the at least one optical element 220 may also temporarily change the effective position and/or the effective orientation of the second non-stereo camera.

In another example of the at least one optical element 220, the at least one optical element 220 may temporarily split the field of view of each of one or more non-stereo cameras of the non-stereo camera module 205, thereby creating overlapping fields of view. Splitting the field of view of a non-stereo camera may in some cases include splitting the pixels of the non-stereo camera into first and second subsets, and using the at least one optical element 220 to temporarily change an effective position of one or both of the subsets, thereby displacing the effective position of the first subset from the effective position of the second subset by a predetermined distance.

In another example of the at least one optical element 220, the at least one optical element 220 may both change the effective position and/or the effective orientation of one non-stereo camera of the non-stereo camera module 205, and split the field of view of the same and/or a different non-stereo camera of the non-stereo camera module 205.

The stereo camera module 210 may perform various functions. In some cases, the stereo camera module 210 may receive a first image captured by a first non-stereo camera of the non-stereo camera module 205 and receive a second image captured by a second non-stereo camera of the non-stereo camera module 205. In other cases, the stereo camera module 210 may receive first and second images from a non-stereo camera having a split field of view. In still other cases, the stereo camera module 210 may receive more than two images, with the images being captured from more than two cameras having different perspectives and overlapping fields of view. In any of these cases, the stereo camera module 210, in conjunction with the at least one optical element 220, may convert one or more non-stereo cameras of the mobile device 105-a into a stereo camera. For example, the stereo camera module 210 may be used to perform a mathematical reconstruction of a scene represented in each of a plurality of images captured by one or more non-stereo cameras of the non-stereo camera module 205. In some cases, the predetermined distance between the effective positions of first and second non-stereo cameras (or between first and second subsets of pixels of a non-stereo camera) may assist the stereo camera module 210 (and/or an off-device processing service with which the stereo camera module 210 communicates) in performing the mathematical reconstruction. For example, the mathematical reconstruction may involve representing objects included in the reconstructed scene to scale, which scale may be identified or determined using the predetermined distance. The mathematical reconstruction may also involve rendering a three-dimensional image of the reconstructed scene. The reconstructed scene may in some cases be output to the display module 215, for viewing by a user of the mobile device 105-a.

The display module 215 may in some cases include a liquid crystal display (LCD) or a light emitting diode (LED) display.

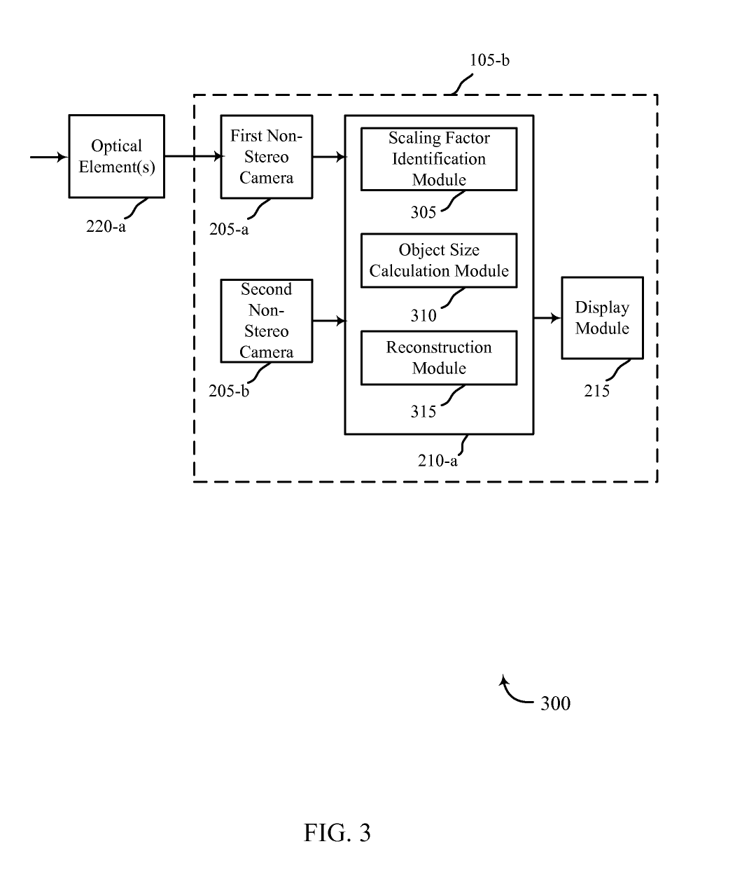

Referring now to FIG. 3, a block diagram 300 illustrates an apparatus including a mobile device 105-b and at least one optical element 220-a for converting non-stereo cameras into a stereo camera, in accordance with various embodiments. The mobile device 105-b may be an example of one or more aspects of the mobile device 105 described with reference to FIGS. 1 and/or 2. The mobile device 105-b may include a first non-stereo camera 205-a, a second non-stereo camera 205-b, a stereo camera module 210-a, and/or a display module 215. Each of these components may be in communication with each other.

The components of the mobile device 105-b may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The first and second non-stereo cameras 205-a, 205-b may be examples of non-stereo cameras of the non-stereo camera module 205 described with reference to FIG. 2. In some cases, the first non-stereo camera 205-a may include a front facing camera of the mobile device 105-b, and the second non-stereo camera 205-b may include a rear facing camera of the mobile device 105-b.

The at least one optical element 220-a may be used to temporarily change an effective position and an effective orientation of the first non-stereo camera 205-a. Changing the effective position of the first non-stereo camera 205-a may involve displacing the effective position of the first non-stereo camera 205-a from an effective position of the second non-stereo camera 205-b by a predetermined distance. Changing the effective orientation of the first non-stereo camera 205-a may involve changing the effective orientation of the first non-stereo camera 205-a to provide the first non-stereo camera 205-a with a field of view that overlaps a field of view of the second non-stereo camera 205-b. When the first and second non-stereo cameras 205-a, 205-b are front and rear facing cameras, respectively, the at least one optical element 220-a may be used to provide the front facing camera a field of view that overlaps the field of view of the rear facing camera.

In some cases, the at least one optical element 220-a may include a mirror that reflects a first image toward the first non-stereo camera 205-a. In other cases, the at least one optical element 220-a may include a lens that focuses the first image at the first non-stereo camera 205-a. In other cases, the at least one optical element 220-a may include a light pipe that propagates the first image toward the first non-stereo camera 205-a. In other cases, the at least one optical element 220-a may include a prism that redirects the first image toward the first non-stereo camera 205-a. The at least one optical element 220-a may also include different types of optical elements and/or combinations of the above and other types of optical elements.

The fields of view of the first and second non-stereo cameras 205 may be the same or different (e.g., consonant with one another or not consonant with one another).

In some cases, the at least one optical element 220 may temporarily fix a displacement between the effective position of the first non-stereo camera 205 and the effective position of the second non-stereo camera 205 by the predetermined distance.

The at least one optical element 220-a may be used to capture a first image with the first non-stereo camera 205-a. A second image may be captured with the second non-stereo camera 205-b. The second image may have a frame of reference that is displaced from a frame of reference of the first image by the predetermined distance established using the at least one optical element 220-a.

In some embodiments, the first and second non-stereo cameras 205-a, 205-b may capture the first and second images simultaneously (e.g., at the same time or in overlapping time periods). In other embodiments, the first and second non-stereo cameras 205-a, 205-b may capture the first and second images sequentially. Regardless of whether the first and second images are captured simultaneously or sequentially, the effective positions of the first and second non-stereo cameras 205-a, 205-b may remain fixed during capture of the first and second images. If the effective positions of the first and second non-stereo cameras 205-a, 205-b do not remain fixed, the predetermined distance between the effective positions of the first and second non-stereo cameras 205-a, 205-b may not be usable during reconstruction of a scene represented in the first and second images.

The stereo camera module 210-a may be an example of one or more aspects of the stereo camera module 210 described with reference to FIG. 2. In some embodiments, the stereo camera module 210-a may include a scaling factor identification module 305, an object size calculation module 310, and/or a reconstruction module 315.

In some embodiments, the scaling factor identification module 305 may be used to identify a scaling factor that is to be applied to at least one common object in the first image and the second image. The scaling factor may be based at least in part on the predetermined distance between the frame of reference of the first image and the frame of reference of the second image, which predetermined distance may be temporarily fixed by attaching the at least one optical element 220-a to the mobile device 105-b.

In some embodiments, the object size calculation module 310 may receive the first and second images captured by the first and second non-stereo cameras 205-a, 205-b and calculate the size of at least one common object in the first and second images. The size of a common object may be calculated based at least in part on the scaling factor and/or the predetermined distance between the frame of reference of the first image and the frame of reference of the second image.

In some embodiments, the reconstruction module 315 may receive the first and second images captured by the first and second non-stereo cameras 205-a, 205-b and perform a mathematical reconstruction of a scene based at least in part on the calculated size of the at least one common object in the first image and the second image. The reconstruction module 315 may in some cases perform a three-dimensional mathematical reconstruction of the scene. The reconstructed scene may in some cases be output to the display module 215, for viewing by a user of the mobile device 105-b.

The display module 215 may be configured similarly to what is described with reference to FIG. 2.

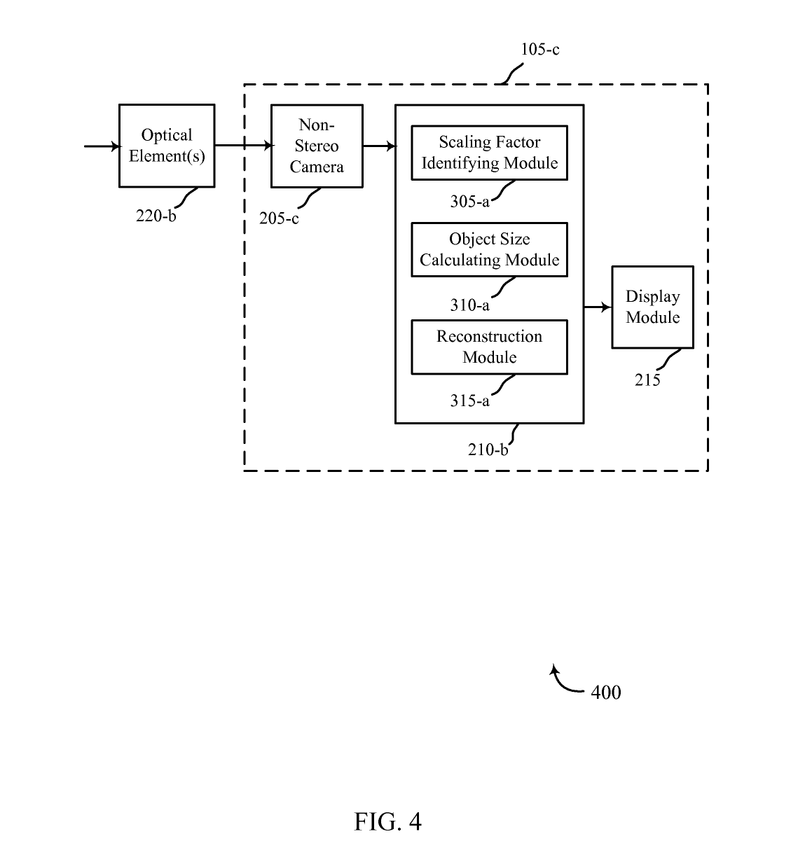

Referring now to FIG. 4, a block diagram 400 illustrates an apparatus including a mobile device 105-c and at least one optical element 220-b for converting a non-stereo camera into a stereo camera, in accordance with various embodiments. The mobile device 105-c may be an example of one or more aspects of the mobile device 105 described with reference to FIGS. 1 and/or 2. The mobile device 105-c may include a non-stereo camera 205-c, a stereo camera module 210-b, and/or a display module 215. Each of these components may be in communication with each other.

The components of the mobile device 105-c may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The non-stereo camera 205-c may be an example of a non-stereo camera of the non-stereo camera module 205 described with reference to FIG. 2. In some cases, the non-stereo camera 205-c may be a rear facing camera of the mobile device 105-c. In some cases, the non-stereo camera 205-c may be a front facing camera of the mobile device 105-c.

The at least one optical element 220-b may be used to temporarily split the field of the non-stereo camera 205-c, thereby creating overlapping fields of view. Splitting the field of view of the non-stereo camera 205-c may in some cases include splitting the pixels of the non-stereo camera into first and second subsets, and using the at least one optical element 220-b to temporarily change an effective position of one or both of the subsets, thereby displacing the effective position of the first subset from the effective position of the second subset by a predetermined distance.

In some cases, the at least one optical element 220-b may include a mirror that reflects a first image toward the first subset of pixels of the non-stereo camera 205-c. In other cases, the at least one optical element 220-b may include a lens that focuses the first image on the first subset of pixels of the non-stereo camera 205-c. In other cases, the at least one optical element 220-b may include a light pipe that propagates the first image toward the first subset of pixels of the non-stereo camera 205-c. In other cases, the at least one optical element 220-b may include a prism that redirects the first image toward the first subset of pixels of the non-stereo camera 205-c. The at least one optical element 220-b may also include different types of optical elements and/or combinations of the above and other types of optical elements. The at least one optical element 220-b may also, or alternately, reflect, focus, propagate, and/or redirect a second image toward the second subset of pixels of the non-stereo camera 205-c.

The fields of view of the first and second subsets of pixels of the non-stereo camera 205-c may be the same or different (e.g., consonant with one another or not consonant with one another).

In some cases, the at least one optical element 220 may temporarily fix a displacement between the effective positions of the first and second subsets of pixels of the non-stereo camera 205 by the predetermined distance.

The at least one optical element 220-b may be used to capture first and second images with the non-stereo camera 205-c. In some cases, the first image may be captured by the first subset of pixels of the non-stereo camera 205-c and the second image may be captured by the second subset of pixels of the non-stereo camera 205-c. The second image may have a frame of reference that is displaced from a frame of reference of the first image by the predetermined distance established using the at least one optical element 220-b.

The effective positions of the first and second subsets of pixels of the non-stereo camera 205-c may remain fixed during capture of the first and second images. If the effective positions of the first and second subsets of pixels do not remain fixed, the predetermined distance between the effective positions of the first and second subsets of pixels may not be usable during reconstruction of a scene represented in the first and second images.

The stereo camera module 210-b may be an example of one or more aspects of the stereo camera module 210 described with reference to FIGS. 2 and/or 3. In some embodiments, the stereo camera module 210-a may include a scaling factor identification module 305-a, an object size calculation module 310-a, and/or a reconstruction module 315-a. The module 305-a, 310-a, and/or 315-a may be an example of the similarly numbered module 305, 310, and/or 315 described with reference to FIG. 3.

In some embodiments, the scaling factor identification module 305-a may be used to identify a scaling factor that is to be applied to at least one common object in the first image and the second image. The scaling factor may be based at least in part on the predetermined distance between the frame of reference of the first image and the frame of reference of the second image, which predetermined distance may be temporarily fixed by attaching the at least one optical element 220-b to the mobile device 105-c.

In some embodiments, the object size calculation module 310-a may receive the first and second images captured by the non-stereo camera 205-c and calculate the size of at least one common object in the first and second images. The size of a common object may be calculated based at least in part on the scaling factor and/or the predetermined distance between the frame of reference of the first image and the frame of reference of the second image.

In some embodiments, the reconstruction module 315-a may receive the first and second images captured by the non-stereo camera 205-c and perform a mathematical reconstruction of a scene based at least in part on the calculated size of the at least one common object in the first image and the second image. The reconstruction module 315-a may also perform a three-dimensional mathematical reconstruction of the scene. The reconstructed scene may in some cases be output to the display module 215, for viewing by a user of the mobile device 105-c.

The display module 215 may be configured similarly to what is described with reference to FIG. 2.

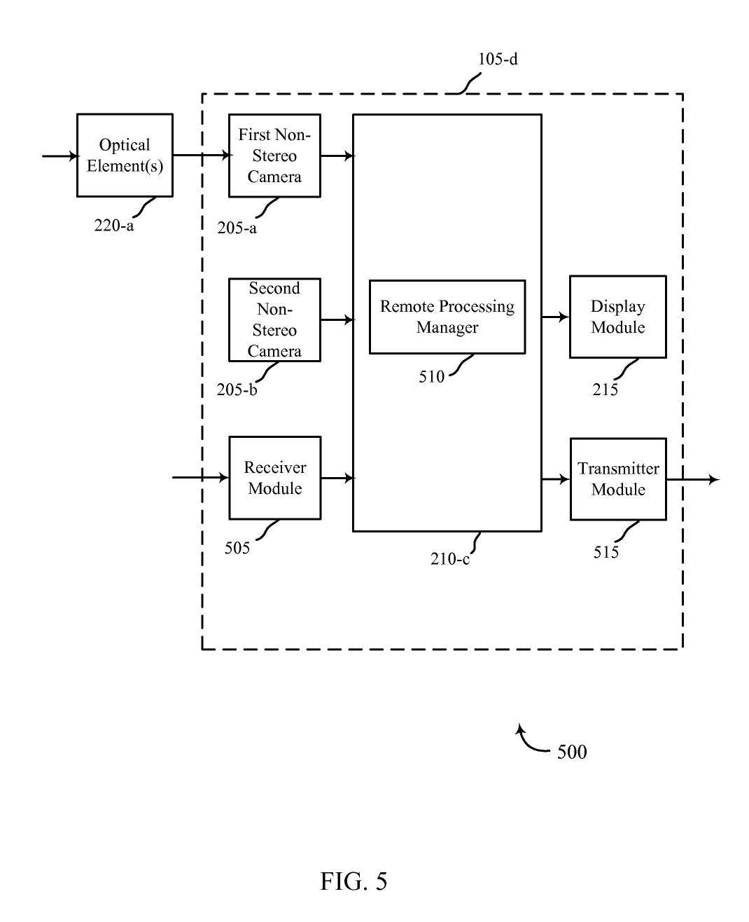

Referring now to FIG. 5, a block diagram 500 illustrates an apparatus including a mobile device 105-d and at least one optical element 220-a for converting non-stereo cameras into a stereo camera, in accordance with various embodiments. The mobile device 105-d may be an example of one or more aspects of the mobile device 105 described with reference to FIGS. 1, 2, and/or 3. The mobile device 105-d may include a first non-stereo camera 205-a, a second non-stereo camera 205-b, a stereo camera module 210-c, a display module 215, a receiver module 505, and/or a transmitter module 515. Each of these components may be in communication with each other.

The components of the mobile device 105-d may, individually or collectively, be implemented using one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The at least one optical element 220-a, the first and second non-stereo cameras 205-a, 205-b, and the display module 215 may be configured similarly to what is described with reference to FIG. 3.

The receiver module 505 may include any number of receivers. In some cases the receiver module 505 may include a cellular receiver. The cellular receiver may in some cases be an LTE/LTE-A receiver or a GSM receiver. The cellular receiver may be used to receive various types of data and/or control signals, collectively referred to as transmissions. The transmissions may be received over one or more communication channels of a wireless communications system such as the wireless communications system 100 described with reference to FIG. 1. In some cases, the receiver module 505 may include an alternate or additional type of receiver, such as an Ethernet or WLAN receiver. The Ethernet or WLAN receiver may also be used to receive various types of data and/or control signals, and may also receive transmissions over one or more communication channels of a wireless communications system such as the wireless communications system 100.

The transmitter module 515 may include any number of transmitters. In some cases the transmitter module 515 may include a cellular transmitter. The cellular transmitter may in some cases be an LTE/LTE-A transmitter or a GSM transmitter. The cellular transmitter may be used to transmit various types of data and/or control signals, collectively referred to as transmissions. The transmissions may be transmitted over one or more communication channels of a wireless communications system such as the wireless communications system 100 described with reference to FIG. 1. In some cases, the transmitter module 515 may include an alternate or additional type of transmitter, such as an Ethernet or WLAN transmitter. The Ethernet or WLAN transmitter may also be used to transmit various types of data and/or control signals, and may also transmit over one or more communication channels of a wireless communications system such as the wireless communications system 100.

The stereo camera module 210-b may be an example of one or more aspects of the stereo camera module 210 described with reference to FIGS. 2 and/or 3. In some embodiments, the stereo camera module 210-b may include a remote processing manager 510. In some embodiments, the remote processing manager 510 may receive respective first and second images from the first and second non-stereo cameras 205-a, 205-b. The remote processing manager 510 may then transmit the first and second images to an off-device processing service via the transmitter module 515. In some cases, the off-device processing service may be hosted at a system such as the central server computer system 120 or the user system 125 described with reference to FIG. 1. The off-site processing service may in some cases perform processing such as the processing performed by the scaling factor identification module 305, the object size calculation module 310, and/or the reconstruction module 315 described with reference to FIG. 3. The off-site processing service may then return the results of its processing, including, in some cases, a mathematical reconstruction of a scene. The processing results may be received at the mobile device 105-d via the receiver module 505. The remote processing manager 510 may then cause a reconstructed scene and/or other image or data to be displayed on the display module 215.

In some cases, a remote processing manager similar to the remote processing manager 510 may be incorporated into either of the mobile devices 105 described with reference to FIGS. 3 and/or 4. A remote processing manager similar to the remote processing manager 510 may also replace the components 305-a, 310-a, 315-a of the stereo camera module 210-b described with reference to FIG. 4.

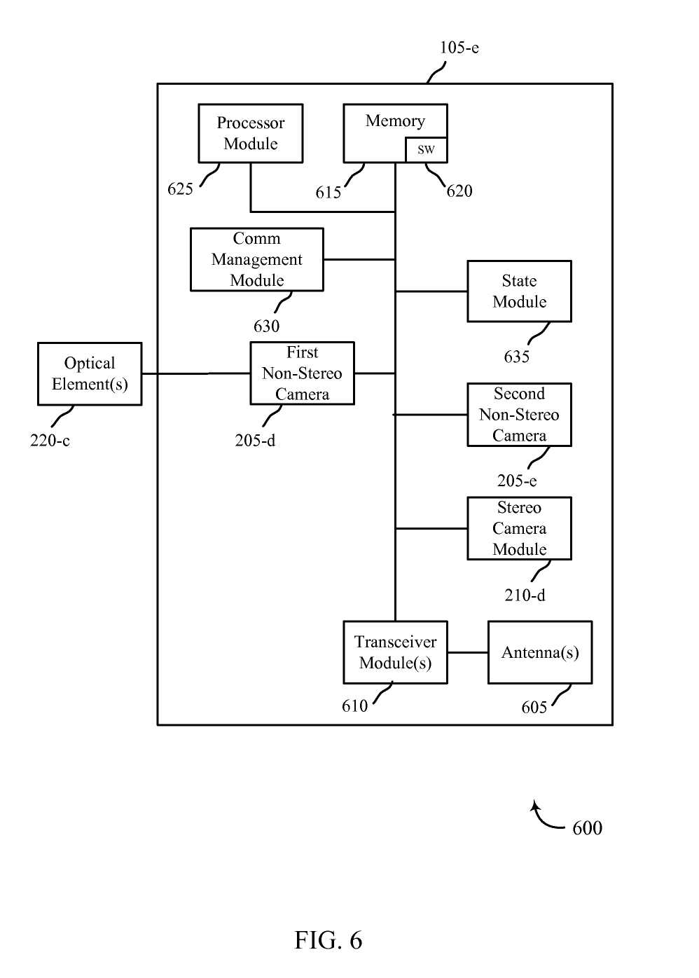

FIG. 6 is an example of a block diagram 600 of a mobile device 105-e. The mobile device 105-e may be an example of one or more aspects of the mobile device 105 described with reference to FIGS. 1, 2, 3, 4, and/or 5. The mobile device 105-e may have any of various configurations and may be, or be included as part of, a cellular telephone, a smart phone, a laptop computer, a PDA, a camera, a gaming device, an e-reader, a tablet computer, a portable digital music player, etc. The mobile device 105-e may have an internal power supply (not shown), such as a small battery, to facilitate mobile operation.

The mobile device 105-e may include antenna(s) 605, transceiver module(s) 610, memory 615, and a processor module 625. Each of these components may be in communication, directly or indirectly, with each other (e.g., via one or more buses). The transceiver module(s) 610 may be configured to communicate bi-directionally, via the antenna(s) 605 and/or one or more wired or wireless links, with one or more networks. For example, the transceiver module(s) 610 may be configured to communicate bi-directionally with one or more of the central server computer system 120 or the user system 125 described with reference to FIG. 1. The transceiver module(s) 610 may also be configured to communicate directly with one or more other mobile devices (e.g., via device to device communications). The transceiver module(s) 610 may include a modem configured to modulate packets and provide modulated packets to the antenna(s) 605 for transmission, and to demodulate packets received from the antenna(s) 605. While the mobile device 105-e may include a single antenna, the mobile device 105-e may typically include multiple antennas for multiple links.

The memory 615 may include random access memory (RAM) and/or read-only memory (ROM). The memory 615 may store computer-readable, computer-executable software (SW) code 620 containing instructions that are configured to, when executed, cause the processor module 625 to perform various functions, including one or more of the functions described herein for identifying a scaling factor, calculating an object size, reconstructing a scene, and/or processing an image or images. Alternatively, the software code 620 may not be directly executable by the processor module 625 but may be configured to cause the mobile device 105-e (e.g., when compiled and executed) to perform one or more of the functions described herein.

The processor module 625 may include an intelligent hardware device, e.g., a CPU, a microcontroller, an ASIC, etc. The processor module 625 may process information received via the antenna(s) 605 and the transceiver module(s) 610, and/or may send information to be transmitted via the transceiver module(s) 610 and the antenna(s) 605. The processor module 625 may handle, alone or in connection with a stereo camera module 210-d, various aspects of capturing images with a first non-stereo camera 205-d and a second non-stereo camera 205-e, and converting one or both of the non-stereo cameras 205-d, 205-e into a stereo camera. In some embodiments, the processor module may be configured to operate the first and second non-stereo cameras 205-d, 205-e to capture respective first and second images for processing using the stereo camera module 210-d.

According to the architecture of FIG. 6, the mobile device 105-e may further include a communications management module 630 and a state module 635. The communications management module 630 may establish and manage communications with other systems 120, 125 and/or other mobile devices 105.

The state module 635 may reflect and control the current device state (e.g., context, authentication, base station association, and/or other connectivity issues).

The mobile device 105-e may further include a first non-stereo camera 205-d, a second non-stereo camera 205-e, and/or a stereo camera module 210-d. The non-stereo cameras 205-d, 205-e may be examples of the non-stereo cameras 205 described with reference to FIGS. 2, 3, 4, and/or 5. The stereo camera module 210 may be an example of the stereo camera module 210 described with reference to FIGS. 2, 3, 4, and/or 5.

At least one optical element 220-c may be used to reflect, focus, propagate, and/or redirect an image toward, or at, the first non-stereo camera 205-d or the second non-stereo camera 205-e, as described with reference to FIGS. 2, 3, 4, and/or 5. Although the at least one optical element 220-c is shown to be associated with the first non-stereo camera 205-d, the at least one optical element 220-c may be alternately associated with the second non-stereo camera 205-e or with both of the non-stereo cameras 205-d, 205-e.

By way of example, each of the communications management module 630, the state module 635, and/or the stereo camera module 210-d may be a component of the mobile device 105-e in communication with some or all of the other components of the mobile device 105-e (e.g., via one or more buses). Alternately, functionality of the communications management module 630, the state module 635, and/or the stereo camera module 210-d may be implemented as components of the transceiver module(s) 610, as a computer program product, and/or as one or more functions or elements of the processor module 625.

The components of the mobile device 105-e may, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the mobile device 105-e.

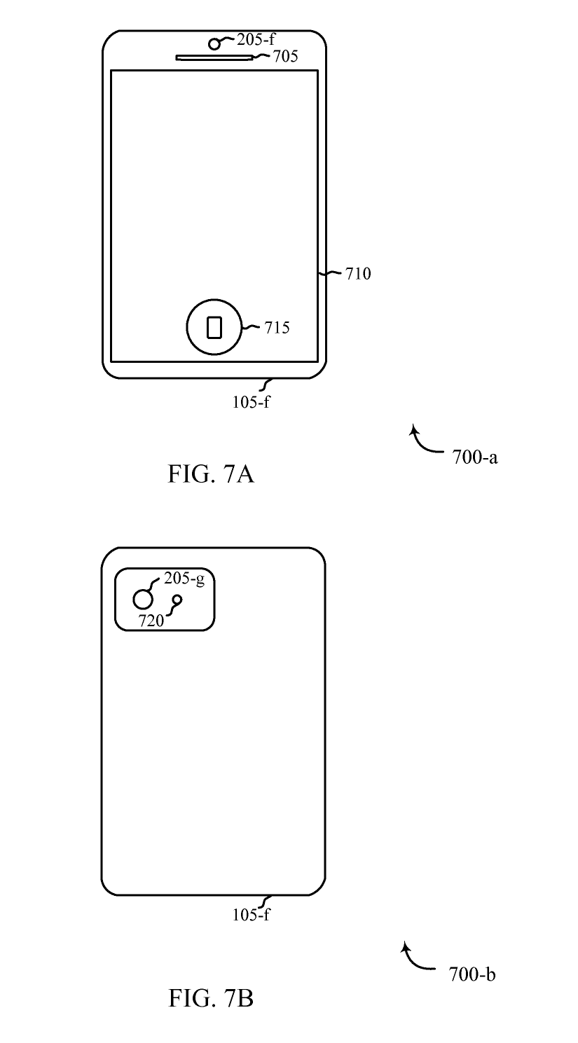

FIGS. 7A and 7B are respective front and rear views 700-a, 700-b of an exemplary mobile device 105-f. The mobile device may be an example of aspects of the mobile device 105 described with reference to FIGS. 1, 2, 3, 4, 5, and/or 6. As shown in FIG. 7A, a front face of the mobile device 105-f may include a front facing camera 205-f, a speaker 705, and/or a touch-sensitive display 710. As shown in FIG. 7B, a rear face of the mobile device 105-f may include a rear facing camera 205-g and/or a camera flash mechanism 720. The front and rear facing cameras 205-f, 205-g may be examples of the non-stereo cameras 205 described with reference to FIGS. 2, 3, 4, 5, and/or 6. Each of the front and rear faces of the mobile device 105-f may also include other components (not shown).

When a stereo camera application is activated on the mobile device 105-f, a graphical button 715 for initiating capture of first and second images may be displayed on the touch-sensitive display 710. A user of the mobile device 105-f may figuratively press the button, thereby initiating capture of the first and second images and possibly other processing. The first and second images may be respectively captured by the front facing camera 205-f and the rear facing camera 205-g.

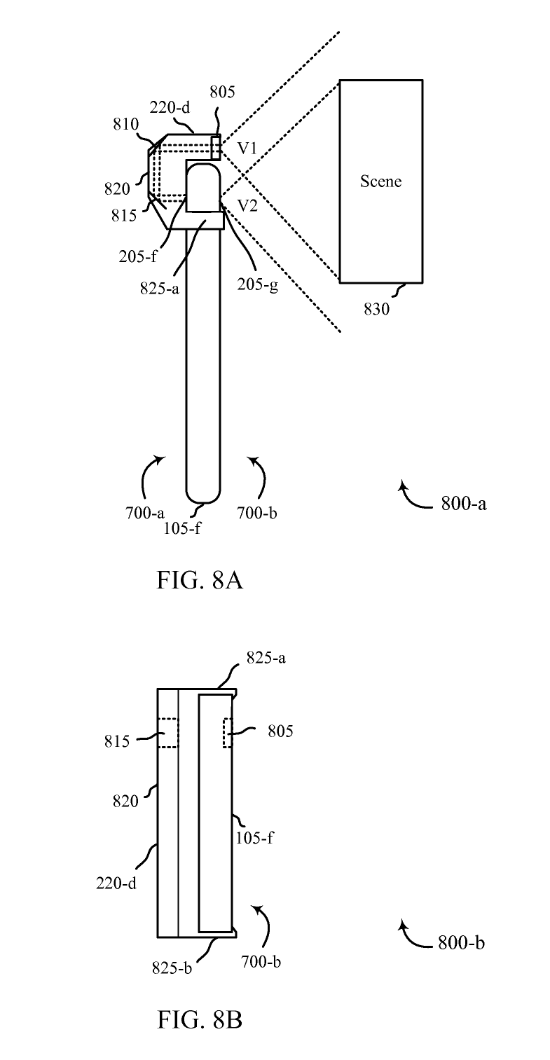

FIG. 8A is a side view 800-a of the exemplary mobile device 105-f shown in FIGS. 7A & 7B, after attachment of at least one optical element 220-d to the mobile device 105-f. The at least one optical element 220-d may be an example of aspects of the at least one optical element 220 described with reference to FIGS. 2, 3, 5, and/or 6. By way of example, the at least one optical element 220-d includes a lens 805 and first and second mirrors 810, 815. The lens 805 and first and second mirrors 810, 815 may be positioned to focus and reflect an image including scene 830 on the front facing camera 205-f, thereby effectively positioning and orienting the front facing camera so that it has a field of view V1 that overlaps a field of view V2 of the rear facing camera 205-g. The scene 830 may be located substantially within the fields of view of both the front and rear facing cameras 205-f, 205-g. The scene may in some cases be mathematically reconstructed in three dimensions as described with reference to FIGS. 2, 3, 5, 10, and/or 11.

FIG. 8B is a bottom view 800-b of the exemplary mobile device 105-f after attachment of the at least one optical element 220-d to the mobile device 105-f. As shown in FIGS. 8A & 8B, the at least one optical element 220-d may be coupled to at least one attachment member 825-a, 825-b. The at least one attachment member 825-a, 825-b may be configured to attach the at least one optical element 220-d to the mobile device 105-f. In some cases, the at least one optical element 220-d may be mounted to, formed in, or otherwise attached to a housing 820. In these cases, the at least one attachment member 825-a, 825-b may extend from, protrude into, or otherwise be coupled to or formed on the housing 820. By way of example, the attachment members 825-a and 825-b are oppositely biased members (e.g., extensions of the housing 820). The oppositely biased members may be configured to snap the at least one optical element, by means of the housing 820, to the mobile device 105-f. In alternate embodiments, the biased members 825-a, 825-b may be supplemented or replaced with straps, suction cups, adhesive, and/or other attachment members.

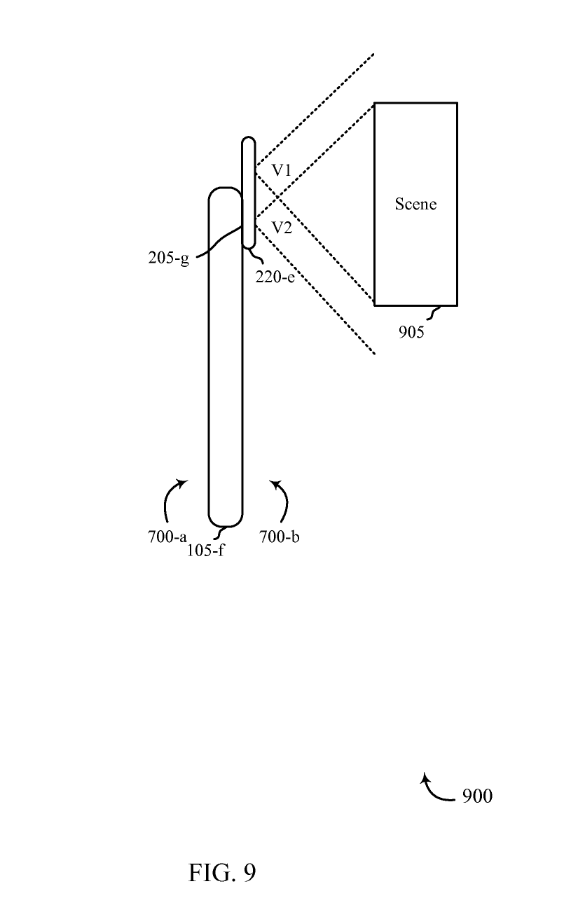

FIG. 9 is another side view 900 of the exemplary mobile device 105-f shown in FIGS. 7A & 7B, after attachment of at least one optical element 220-e to the mobile device 105-f. The at least one optical element 220-e may be an example of aspects of the at least one optical element 220 described with reference to FIGS. 2, 3, 4, and/or 6. By way of example, the at least one optical element 220-e may include one or more of a mirror, a lens, a light pipe, and a prism. The at least one optical element 220-e may be positioned to split the field of view of the rear facing camera 205-g into first and second overlapping fields of view V1 and V2. Splitting the field of view of the rear facing camera 205-g may in some cases include splitting the pixels of the rear facing camera 205-g into first and second subsets, and using the at least one optical element 220-e to temporarily change an effective position of one or both of the subsets, thereby displacing the effective position of the first subset from the effective position of the second subset by a predetermined distance. The scene 905 may be located substantially within each of the fields of view (i.e., within the fields of view V1 and V2). The scene may in some cases be mathematically reconstructed in three dimensions, as described with reference to FIGS. 2, 4, 11, and/or 12.

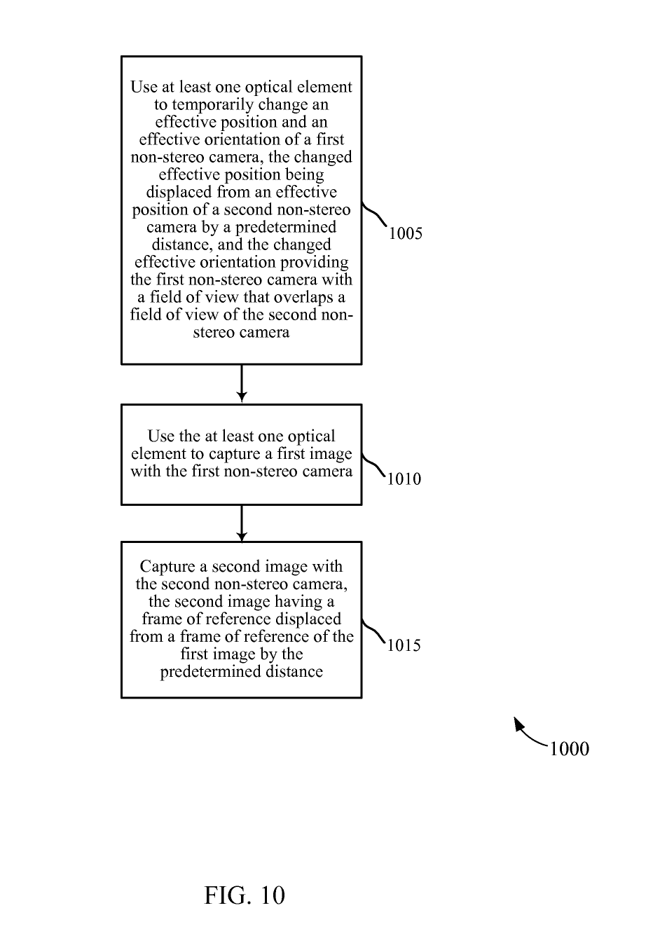

FIG. 10 is a flow chart illustrating an example of a method 1000 for converting non-stereo cameras into a stereo camera, in accordance with various embodiments. For clarity, the method 1000 is described below with reference to one of the mobile devices 105 described with reference to FIGS. 1, 2, 3, 5, 6, 7A, 7B, 8A, and/or 8B, first and second of the non-stereo cameras 205 described with reference to FIGS. 2, 3, 5, 6, 7A, 7B, 8A, and/or 8B, and/or the at least one optical element 220 described with reference to FIGS. 2, 3, 5, 6, 8A, and/or 8B.

At block 1005, at least one optical element 220 may be used to temporarily change an effective position and an effective orientation of a first non-stereo camera 205. Changing the effective position of the first non-stereo camera 205 may involve displacing the effective position of the first non-stereo camera 205 from an effective position of a second non-stereo camera 205 by a predetermined distance. Changing the effective orientation of the first non-stereo camera 205 may involve changing the effective orientation of the first non-stereo camera 205 to provide the first non-stereo camera 205 with a field of view that overlaps a field of view of the second non-stereo camera 205.

In some cases, the first non-stereo camera 205 may include a front facing camera of a mobile device 105, and the second non-stereo camera 205 may include a rear facing camera of the mobile device 105. In these cases, changing the effective position and the effective orientation of the first non-stereo camera 205 may involve using the at least one optical element 220 to provide the front facing camera a field of view that overlaps the field of view of the rear facing camera.

In some cases, the at least one optical element 220 may include a mirror that reflects a first image toward the first non-stereo camera 205. In other cases, the at least one optical element 220 may include a lens that focuses the first image at the first non-stereo camera 205. In other cases, the at least one optical element 220 may include a light pipe that propagates the first image toward the first non-stereo camera 205. In other cases, the at least one optical element 220 may include a prism that redirects the first image toward the first non-stereo camera 205. The at least one optical element 220 may also include different types of optical elements and/or combinations of the above and other types of optical elements.

The fields of view of the first and second non-stereo cameras 205 may be the same or different (e.g., consonant with one another or not consonant with one another).

In some cases, the at least one optical element 220 may temporarily fix a displacement between the effective position of the first non-stereo camera 205 and the effective position of the second non-stereo camera 205 by the predetermined distance.

The operation(s) at block 1005 may in some cases be performed by a user of a mobile device 105 and the at least one optical element 220.

At block 1010, the at least one optical element 220 may be used to capture a first image with the first non-stereo camera 205. The operation(s) at block 1010 may in some cases be performed by a user of a mobile device 105 and the at least one optical element 220, with assistance from automatic or semi-automatic operation of the first non-stereo camera 205.

At block 1015, a second image may be captured with the second non-stereo camera 205. The second image may have a frame of reference that is displaced from a frame of reference of the first image by the predetermined distance established at block 1005. The operation(s) at block 1015 may in some cases be performed by a user of a mobile device 105 and the at least one optical element 220, with assistance from automatic or semi-automatic operation of the second non-stereo camera 205.

In some embodiments, the first and second images may be captured simultaneously (e.g., at the same time or in overlapping time periods). In other embodiments, the first and second images may be captured sequentially. Regardless of whether the first and second images are captured simultaneously or sequentially, the effective positions of the first and second non-stereo cameras 205 should remain fixed during capture of the first and second images. If the effective positions of the first and second non-stereo cameras 205 do not remain fixed, the predetermined distance between the effective positions of the first and second non-stereo cameras 205 may not be usable during reconstruction of a scene represented in the first and second images.

The at least one optical element 220 may in some cases be used to convert the first and second non-stereo cameras 205 into a stereo camera. In addition, the predetermined distance between the effective positions of the first and second non-stereo cameras 205 may assist a mobile device 105 in which the cameras 205 are housed (and/or an off-device processing service accessible to the mobile device 105) in performing a mathematical reconstruction of a scene represented in the first and second images captured by the first and second non-stereo cameras 205. The mathematical reconstruction may involve representing objects included in the reconstructed scene to scale, which scale may be identified or determined using the predetermined distance. The mathematical reconstruction may also involve rendering a three-dimensional image of the reconstructed scene.

Thus, the method 1000 may provide for converting non-stereo cameras into a stereo camera. It should be noted that the method 1000 is just one implementation and that the operations of the method 1000 may be rearranged or otherwise modified such that other implementations are possible.

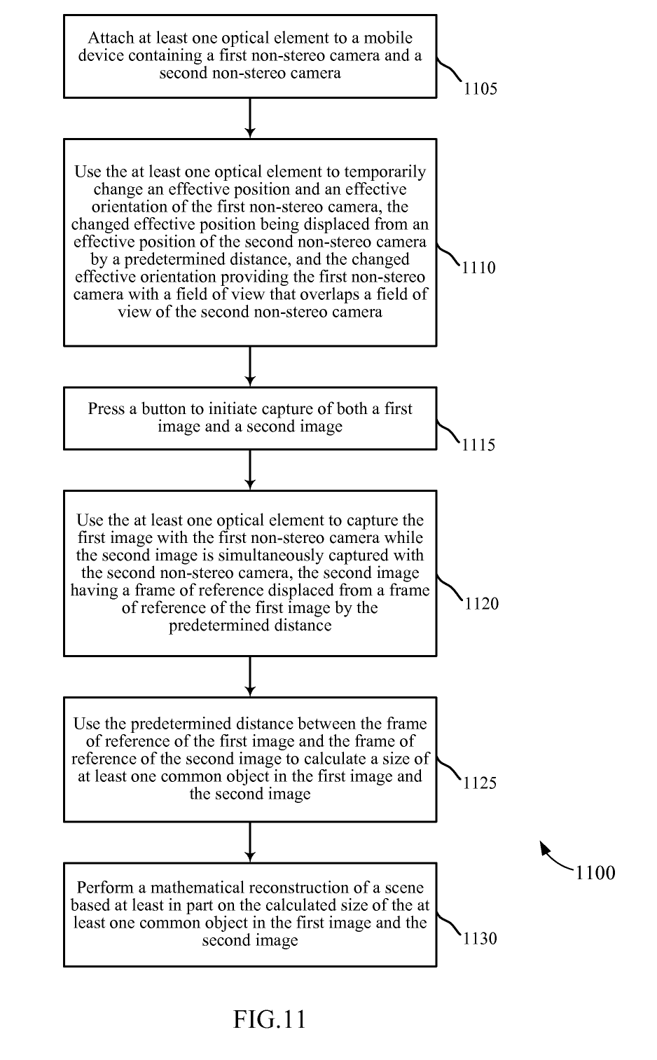

FIG. 11 is a flow chart illustrating an example of a method 1100 for converting non-stereo cameras into a stereo camera, in accordance with various embodiments. For clarity, the method 1100 is described below with reference to one of the mobile devices 105 described with reference to FIGS. 1, 2, 3, 5, 6, 7A, 7B, 8A, and/or 8B, first and second of the non-stereo cameras 205 described with reference to FIGS. 2, 3, 5, 6, 7A, 7B, 8A, and/or 8B, and/or the at least one optical element 220 described with reference to FIGS. 2, 3, 5, 6, 8A, and/or 8B.

At block 1105, at least one optical element 220 may be attached to a mobile device 105 containing a first non-stereo camera 205 and a second non-stereo camera 205. Attaching the at least one optical element 220 to the mobile device 105 may in some cases include snapping the at least one optical element to the mobile device 105. Attaching the at least one optical element 220 may also include, for example, strapping, suctioning, and/or sticking (e.g., adhesively attaching) the at least one optical element 220 to the mobile device 105. In some cases the at least one optical element 220 may include one or more optical elements mounted in or on a device that attaches to the mobile device 105 as a single unit.

The at least one optical element 220 may be used at block 1110 to temporarily change an effective position and an effective orientation of the first non-stereo camera 205. Changing the effective position of the first non-stereo camera 205 may involve displacing the effective position of the first non-stereo camera 205 from an effective position of a second non-stereo camera 205 by a predetermined distance. Changing the effective orientation of the first non-stereo camera 205 may involve changing the effective orientation of the first non-stereo camera 205 to provide the first non-stereo camera 205 with a field of view that overlaps a field of view of the second non-stereo camera 205.

In some cases, the first non-stereo camera 205 may include a front facing camera of a mobile device 105, and the second non-stereo camera 205 may include a rear facing camera of the mobile device 105. In these cases, changing the effective position and the effective orientation of the first non-stereo camera 205 may involve using the at least one optical element 220 to provide the front facing camera a field of view that overlaps the field of view of the rear facing camera.

In some cases, the act of attaching the at least one optical element 220 to the mobile device 105 may result in using the at least one optical element 220 to temporarily change the effective position and the effective orientation of the first non-stereo camera 205. In other cases, using the at least one optical element 220 to temporarily change the effective position and the effective orientation of the first non-stereo camera 205 may include positioning and/or adjusting the at least one optical element 220 after attachment.

In some cases, the at least one optical element 220 may include a mirror that reflects a first image toward the first non-stereo camera 205. In other cases, the at least one optical element 220 may include a lens that focuses the first image at the first non-stereo camera 205. In other cases, the at least one optical element 220 may include a light pipe that propagates the first image toward the first non-stereo camera 205. In other cases, the at least one optical element 220 may include a prism that redirects the first image toward the first non-stereo camera 205. The at least one optical element 220 may also include different types of optical elements and/or combinations of the above and other types of optical elements.

The fields of view of the first and second non-stereo cameras 205 may be the same or different (e.g., consonant with one another or not consonant with one another).

In some cases, the at least one optical element 220 may temporarily fix a displacement between the effective position of the first non-stereo camera 205 and the effective position of the second non-stereo camera 205 by the predetermined distance.

At block 1115, a button may be pressed to initiate capture of both a first image and a second image. In some cases, the button may be a button on the mobile device 105 that is capable of being manually pressed, such as button on an edge or face of the mobile device 105. In other cases, the button may be a graphical element rendered on a touch-sensitive display of the mobile device 105, which button may be figuratively pressed (e.g., by touching the button on the touch-sensitive display).

The operation(s) at block 1105, 1110, and/or 1115 may in some cases be performed by a user of a mobile device 105 and the at least one optical element 220.

At block 1120, the at least one optical element 220 may be used to capture the first image with the first non-stereo camera 205 while the second non-stereo camera 205 simultaneously captures the second image. In some cases, the first non-stereo camera 205 may capture the first image as a result of the at least one optical element 220 reflecting, focusing, propagating, and/or redirecting the first image toward or at the first non-stereo camera 205. The second image may have a frame of reference that is displaced from a frame of reference of the first image by the predetermined distance established at block 1110. Simultaneously capturing the first and second images may include capturing the first and second images at the same time or in overlapping time periods. The operation(s) at block 1120 may in some cases be performed by a user of a mobile device 105 and the at least one optical element 220, with assistance from the automatic or semi-automatic operation of the first and second non-stereo cameras 205.

The effective positions of the first and second non-stereo cameras 205 should remain fixed during capture of the first and second images. If the effective positions of the first and second non-stereo cameras 205 do not remain fixed, the predetermined distance between the effective positions of the first and second non-stereo cameras 205 may not be usable during reconstruction of a scene represented in the first and second images.

The at least one optical element 220 may in some cases be used to convert the first and second non-stereo cameras 205 into a stereo camera. In this regard, and at block 1125, pressing the button at block 1115 may cause the mobile device 105 to calculate a size of at least one common object in the first image and the second image based at least in part on the predetermined distance between the frame of reference of the first image and the frame of reference of the second image. At block 1130, and in further response to pressing the button at block 1115, a mathematical reconstruction of a scene may be performed. The mathematical reconstruction may be based at least in part on the calculated size of the at least one common object in the first image and the second image, and may involve representing objects included in the reconstructed scene to scale based on the calculated size of the at least one common object. The mathematical reconstruction may also involve rendering a three-dimensional image of the reconstructed scene.

In some embodiments, the operations performed at block 1125 and/or 1130 may be performed by an off-device processing service. The off-device processing service may be accessed, for example, via wireless or wired communications between the mobile device 105 and a host of the off-device processing service.

Thus, the method 1100 may provide for converting non-stereo cameras into a stereo camera. It should be noted that the method 1100 is just one implementation and that the operations of the method 1100 may be rearranged or otherwise modified such that other implementations are possible.

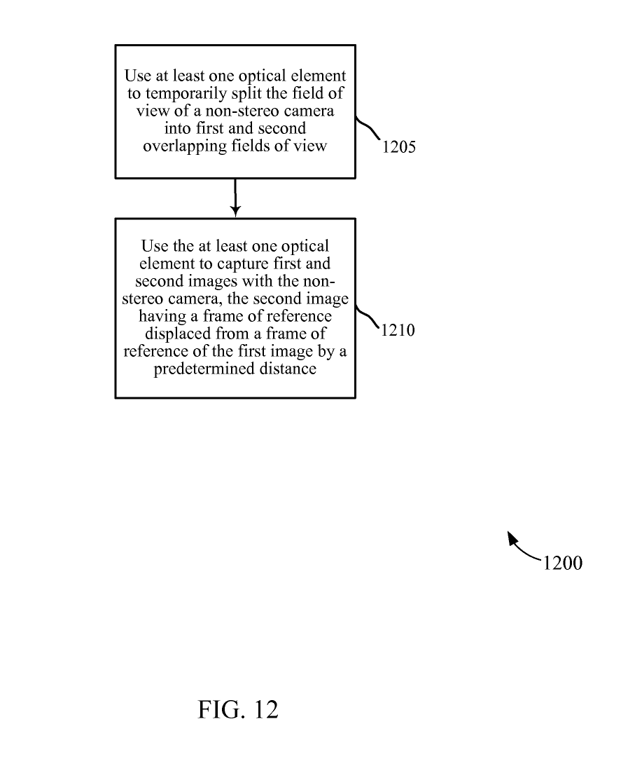

FIG. 12 is a flow chart illustrating an example of a method 1200 for converting a non-stereo camera into a stereo camera, in accordance with various embodiments. For clarity, the method 1200 is described below with reference to one of the mobile devices 105 described with reference to FIGS. 1, 4, 6, 7A, 7B, and/or 9, the non-stereo camera 205 described with reference to FIGS. 4, 6, 7A, 7B, and/or 9, and/or the at least one optical element 220 described with reference to FIGS. 4, 6, 7A, 7B, and/or 9.

At block 1205, at least one optical element 220 may be used to temporarily split the field of view of a non-stereo camera 205 into first and second overlapping fields of view. Splitting the field of view of the non-stereo camera 205 may in some cases include splitting the pixels of the non-stereo camera 205 into first and second subsets, and using the at least one optical element 220 to temporarily change an effective position of one or both of the subsets, thereby displacing the effective position of the first subset from the effective position of the second subset by a predetermined distance.

In some cases, the non-stereo camera 205 may include a rear facing camera of a mobile device 105. In other cases, the non-stereo camera 205 may include a front facing camera of the mobile device 105.

In some cases, the at least one optical element 220 may include a mirror that reflects a first image toward the first subset of pixels of the non-stereo camera 205. In other cases, the at least one optical element 220 may include a lens that focuses the first image on the first subset of pixels of the non-stereo camera 205. In other cases, the at least one optical element 220 may include a light pipe that propagates the first image toward the first subset of pixels of the non-stereo camera 205. In other cases, the at least one optical element 220 may include a prism that redirects the first image toward the first subset of pixels of the non-stereo camera 205. The at least one optical element 220 may also include different types of optical elements and/or combinations of the above and other types of optical elements. The at least one optical element 220 may also, or alternately, reflect, focus, propagate, and/or redirect a second image toward the second subset of pixels of the non-stereo camera 205.

The fields of view of the first and second non-stereo cameras 205 may be the same or different (e.g., consonant with one another or not consonant with one another).

In some cases, the at least one optical element 220 may temporarily fix a displacement between the effective positions of the first and second subsets of pixels of the non-stereo camera 205 by the predetermined distance.

The operation(s) at block 1205 may in some cases be performed by a user of a mobile device 105 and the at least one optical element 220.

At block 1210, the at least one optical element 220 may be used to capture first and second images with the non-stereo camera 205. In some cases, the first image may be captured by the first subset of pixels of the non-stereo camera 205 and the second image may be captured by the second subset of pixels of the non-stereo camera 205. The second image may have a frame of reference that is displaced from a frame of reference of the first image by the predetermined distance established at block 1205. The operation(s) at block 1210 may in some cases be performed by a user of a mobile device 105 and the at least one optical element 220, with assistance from automatic or semi-automatic operation of the non-stereo camera 205.

The effective positions of the first and second subsets of pixels of the non-stereo camera 205 should remain fixed during capture of the first and second images. If the effective positions of the first and second subsets of pixels do not remain fixed, the predetermined distance between the effective positions of the first and second subsets of pixels may not be usable during reconstruction of a scene represented in the first and second images.

The at least one optical element 220 may in some cases be used to convert the non-stereo camera 205 into a stereo camera. In addition, the predetermined distance between the effective positions of the first and second subsets of pixels of the non-stereo camera 205 may assist a mobile device 105 in which the camera 205 is housed (and/or an off-device processing service accessible to the mobile device 105) in performing a mathematical reconstruction of a scene represented in the first and second images captured by the non-stereo camera 205. The mathematical reconstruction may involve representing objects included in the reconstructed scene to scale, which scale may be identified or determined using the predetermined distance. The mathematical reconstruction may also involve rendering a three-dimensional image of the reconstructed scene.

Thus, the method 1200 may provide for converting non-stereo cameras into a stereo camera. It should be noted that the method 1200 is just one implementation and that the operations of the method 1200 may be rearranged or otherwise modified such that other implementations are possible.

In some cases, different ones of the methods 1000, 1100, 1200, or operations thereof, may be combined. For example, the method 1200 may be combined with the method 1000 or method 1100 to provide a camera with first, second, and third images from which a scene may be reconstructed. When combining the method 1200 with the method 1000 or the method 1100, the field of view of either or both of the first and second non-stereo cameras may be split. The methods 1000, 1100, 1200, or operations thereof, may also be combined in other ways.

The detailed description set forth above in connection with the appended drawings describes exemplary embodiments and does not represent the only embodiments that may be implemented or that are within the scope of the claims. The term “example” or “exemplary,” when used in this description, means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

Some of the functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for converting non-stereo cameras into a stereo camera, comprising:
using at least one optical element to temporarily change an effective position and an effective orientation of a first non-stereo camera, the changed effective position being displaced from an effective position of a second non-stereo camera by a predetermined distance, and the changed effective orientation providing the first non-stereo camera with a field of view that overlaps a field of view of the second non-stereo camera;
using the at least one optical element, capturing a first image with the first non-stereo camera; and
capturing a second image with the second non-stereo camera, the second image having a frame of reference displaced from a frame of reference of the first image by the predetermined distance.

2. The method of claim 1, wherein the at least one optical element temporarily fixes a displacement between the effective position of the first non-stereo camera and an effective position of the second non-stereo camera by the predetermined distance.

3. The method of claim 1, wherein the at least one optical element comprises a mirror that reflects the first image toward the first non-stereo camera.

4. The method of claim 1, wherein the at least one optical element comprises a lens that focuses the first image at the first non-stereo camera.

5. The method of claim 1, wherein the at least one optical element comprises a light pipe that propagates the first image toward the first non-stereo camera.

6. The method of claim 1, further comprising:
attaching the at least one optical element to a mobile device containing the first non-stereo camera and the second non-stereo camera.

7. The method of claim 1, further comprising:
snapping the at least one optical element to a mobile device containing the first non-stereo camera and the second non-stereo camera.

8. The method of claim 1, wherein the first non-stereo camera comprises a front facing camera of a mobile device and the second non-stereo camera comprises a rear facing camera of the mobile device.

9. The method of claim 1, wherein the first image and the second image are captured simultaneously.

10. The method of claim 1, further comprising:
pressing a button to initiate capture of both the first image and the second image.

11. The method of claim 1, wherein pressing the button causes a mobile device to:
calculating a size of at least one common object in the first image and the second image based at least in part on the predetermined distance between the frame of reference of the first image and the frame of reference of the second image.

12. The method of 11, wherein pressing the button further causes the mobile device to:
perform a mathematical reconstruction of a scene based at least in part on the calculated size of the at least one common object in the first image and the second image.

13. The method of claim 1, further comprising:
using the at least one optical element to temporarily split the field of view of the first non-stereo camera into first and second overlapping fields of view.

14. The method of claim 1, further comprising:
using the at least one optical element to temporarily split the field of view of the second non-stereo camera into first and second overlapping fields of view.

15. Apparatus for converting non-stereo cameras into a stereo camera, comprising:
means for capturing a first image;
means for capturing a second image, the second image having a frame of reference displaced from a frame of reference of the first image by a predetermined distance;
optical means for temporarily changing an effective position and an effective orientation of the means for capturing the first image while capturing the first image, the changed effective position being displaced from an effective position of the means for capturing the second image by the predetermined distance, and the changed effective orientation providing the means for capturing the first image with a field of view that overlaps a field of view of the means for capturing the second image.

16. The apparatus of claim 15, wherein the optical means temporarily fixes a displacement between the effective position of the means for capturing the first image and an effective position of the means for capturing the second image by the predetermined distance.

17. The apparatus of claim 15, wherein the optical means comprises:
means for reflecting the first image toward the means for capturing the first image.

18. The apparatus of claim 15, wherein the optical means comprises:
means for focusing the first image at the means for capturing the first image.

19. The apparatus of claim 15, wherein the optical means comprises:
means for propagating the first image toward the means for capturing the first image.

20. The apparatus of claim 15, further comprising:
means for attaching the optical means to a mobile device containing the means for capturing the first image and the means for capturing the second image.

21. The apparatus of claim 15, further comprising:
means for snapping the optical means to a mobile device containing the means for capturing the first image and the means for capturing the second image.

22. Apparatus for converting non-stereo cameras into a stereo camera, comprising:
a first non-stereo camera to capture a first image;
a second non-stereo camera to capture a second image, the second image having a frame of reference displaced from a frame of reference of the first image by a predetermined distance;
at least one optical element for temporarily changing an effective position and an effective orientation of the first non-stereo camera during capture of the first image, the changed effective position being displaced from an effective position of the second non-stereo camera by the predetermined distance, and the changed effective orientation providing the first non-stereo camera with a field of view that overlaps a field of view of the second non-stereo camera.

23. The apparatus of claim 22, wherein the at least one optical element temporarily fixes a displacement between the effective position of the first non-stereo camera and an effective position of the second non-stereo camera by the predetermined distance.

24. The apparatus of claim 22, wherein the at least one optical element comprises a mirror that reflects the first image toward the first non-stereo camera.

25. A device for converting non-stereo cameras into a stereo camera, comprising:
at least one optical element for temporarily changing an effective position and an effective orientation of a first non-stereo camera during capture of a first image, the changed effective position being displaced from an effective position of a second non-stereo camera by a predetermined distance, and the changed effective orientation providing the first non-stereo camera with a field of view that overlaps a field of view of the second non-stereo camera; and
at least one attachment member configured to attach the at least one optical element to a mobile device containing the first non-stereo camera and the second non-stereo camera.

26. The device of claim 25, wherein the at least one attachment member comprises:
at least one biased member configured to snap the at least one optical element to a mobile device containing the first non-stereo camera and the second non-stereo camera.

27. The device of claim 25, wherein:
the first non-stereo camera comprises a front facing camera of a mobile device; and
the second non-stereo camera comprises a rear facing camera of the mobile device.

28. The device of claim 25, wherein the at least one optical element comprises a mirror that reflects the first image toward the first non-stereo camera.

29. The device of claim 25, wherein the at least one optical element comprises a lens that focuses the first image at the first non-stereo camera.

30. The device of claim 25, wherein the at least one optical element comprises a light pipe that propagates the first image toward the first non-stereo camera.
